(19) United States
(12) Patent Application Publication
(10) Pub. No.: US 2006/0018188 A1
(43) Pub. Date: Jan. 26, 2006

(54) Mixture preparation device for two fluids

(76) Inventor: Pierre Gariepy, Kirkland (CA)

Correspondence Address: Mila Shvartsman, P.O. Box 48652, CSP Outremont, QC, H2V 4T9, CA

(21) Appl. No.: 11/150,877

(22) Filed: Jun. 13, 2005

Related U.S. Application Data
(60) Provisional application No. 60/584,333, filed on Jul. 1, 2004.

(51) Int. Cl. B01F 13/00

(52) U.S. Cl. 366/130; 366/341

(57) ABSTRACT

The present invention relates to a mixture preparation device for mixing two fluids comprising a first container for primary fluid and a secondary container for secondary fluid. These containers have a configuration wherein volume to height ratio of fluid in each container remains identical, and they are adapted to be placed side by side on a common surface. The desired ratio is obtained when the primary fluid of the first container is filled up to the same level as the secondary fluid in the second container. The second container is a variable capacity container, comprising a capacity changing means that allows selection of a desired ratio. The capacity changing means is a vertically oriented movable partition adapted to be moved inside the container. This movable partition divides the second chamber in an airtight manner.

The present invention is related to a device for mixing fluids, and more particularly to a device for mixing two fluids according to a desired ratio.

### BACKGROUND OF THE INVENTION

There are known different engines requiring a predetermined mixture of oil and gasoline. The proportional relationship or ratio of volume between gasoline and oil for preparation of such mixtures is different for each application and depends on the type of the engine or manufacturer specifications. For example, some lawnmower engines require 32 parts of gasoline to 1 part of oil. Outboard engines for some boats require 50 parts of gasoline to 1 part of oil, and so on. It is important to be sure that the mixture is prepared exactly to the ratio specifications to avoid breakage, poor performance of the engine, or voiding the manufacturer's warranty.

In practice, most of the ratios currently used on the market fall in the range between 10 to 100 parts of primary fluid (fluid that occupies the highest volume of mixture) to 1 part of secondary fluid (fluid that occupies the lowest volume in the mixture). In order to prepare the mixture, the user must know the exact quantity of primary fluid which he possesses in order to correctly calculate the quantity of secondary fluid to produce the mixture according to desired ratio. When the quantity of primary fluid in the container is not known precisely, manual intervention and manipulation of primary fluid must be done in order to establish a known quantity before being able to prepare the final mixture. Furthermore, using different engines necessitating mixtures of different ratio increases the complexity of the work and the risk of producing a bad mixture for the engine.

The present invention eases the preparation of desired mixtures while reducing time for manipulation, calculation, health risk and increases safety of operation.

### SUMMARY OF THE INVENTION

The mixture preparation device according to the present invention comprises two types of containers: first container for primary fluid and second container for secondary fluid. Secondary container may be of fixed capacity or a variable capacity provided with means to change capacity according to specification. Both containers are coupled together to assure a common base.

To prepare a desired mixture, the user sets the secondary container to a desired capacity or chooses a fixed container according to a desired capacity. Both containers are coupled together, and primary and secondary fluids are introduced into both containers. The most important point of the present invention is that fluids must align to the same level in both containers to facilitate the desired mixture according to the appropriate ratio.

### BRIEF DESCRIPTION OF THE DRAWINGS

In the drawings that illustrate the invention:

FIG. 1 shows a top view of the device according to the present invention depicting a cross-sectional view of second container along the line A-A.

FIG. 2 shows a right side view of FIG. 1.

FIG. 3 shows back side view of FIG. 1.

FIG. 4 shows a right side view of FIG. 1 depicting a cross-sectional view of second container.

FIG. 5 shows a front side view of fixed capacity container.

FIG. 6 shows a perspective disassembled view of FIG. 1.

FIG. 7 shows a perspective disassembled view of second embodiment of the present invention illustrating fixed capacity container.

### DETAILED DESCRIPTION OF THE PRESENT INVENTION

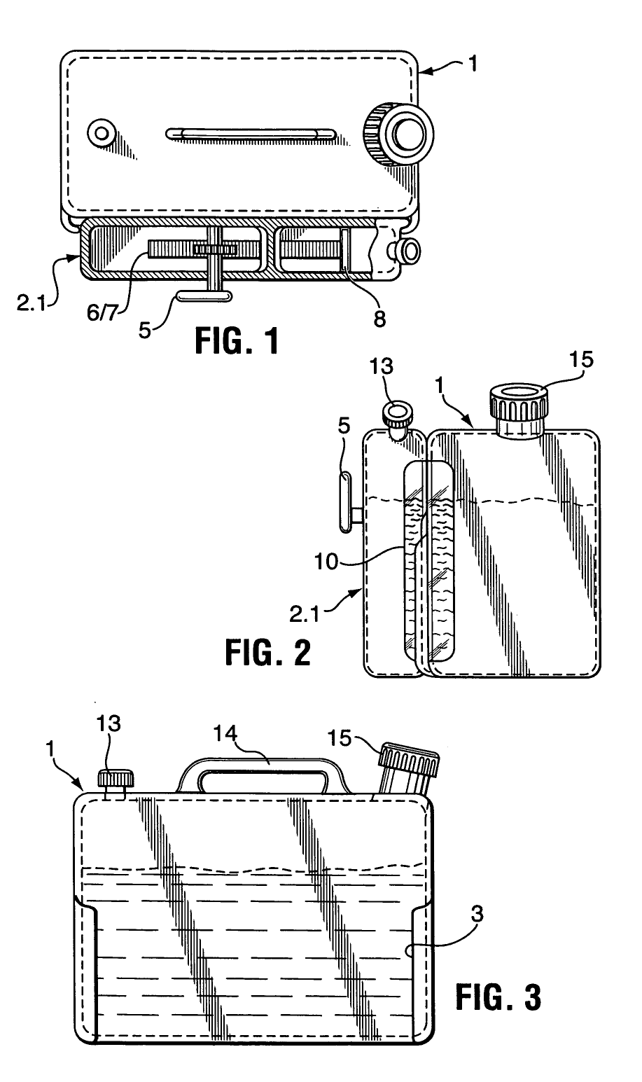

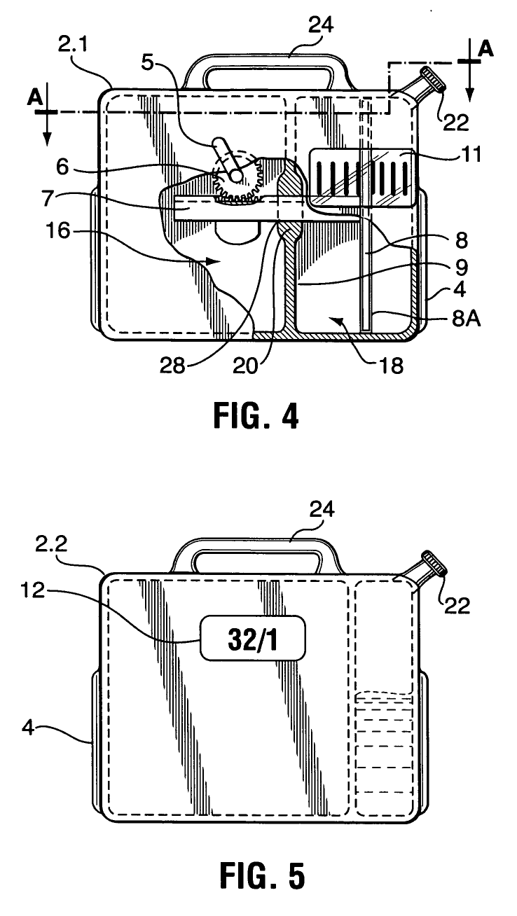

Referring now to drawings, FIGS. 1-6 show a device for mixture of two fluids comprising a first container 1 adapted for primary fluid and a second container 2.1 adapted for secondary fluid. In one embodiment, said second container is a variable capacity container 2.1 as shown on FIGS. 1 and 4. In the other embodiment, second container 2.2 (FIG. 5 and 7) is of a fixed capacity. Containers 1 and 2.1 or 2.2 are joined at their base together by an interlocking means such as sleeve 3 and rails 4 formed along adjacent walls of container 1 and 2.1. Primary container has a handle 14 on top of said container, an opening covered by a cap 15 for pouring fluid into and out of the container and a ventilation opening provided with a cap 13.

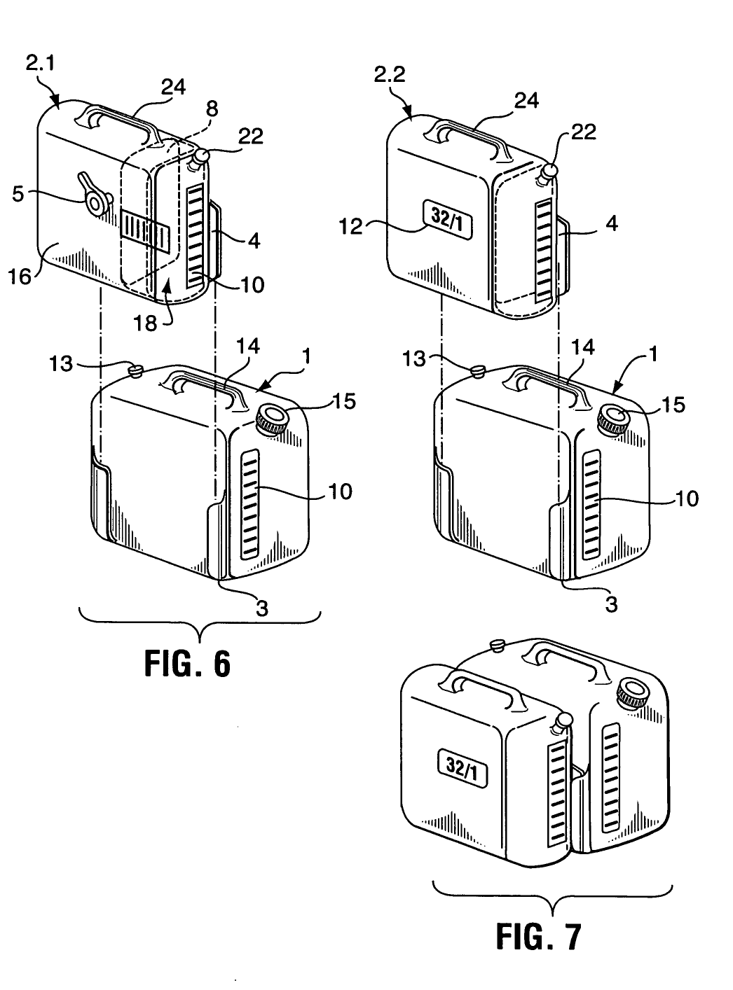

Preferably, but not necessarily, interlocking means to couple both containers is combination of set of U-shaped sleeves 3 formed on vertical wall of the first container which is adapted to be engaged with set of rails 4 formed on vertical wall of second container. Sleeves 3 and rails 4 cover half of height of both containers and are formed on walls facing each other (see FIG. 6).

Second container 2.1 or 2.2 also has a handle 24 located on top and an opening for pouring fluid into and out provided with cap 22.

Preferably but not necessarily, both containers 1 and 2.1 or 2.2 generally have rectangular configuration and are of the same height. Any other configuration of both containers is possible; however it is important to follow the proportions of both containers according to the new features described below.

Variable capacity container 2.1 is separated inside by a fixed vertical partition or wall 9 covering the full height and width of the container 2.1. Partition 9 divides container 2.1 into two chambers 16 and 18 of an approximate proportion 60% for chamber 16 and 40% for chamber 18. Fixed partition 9 contains an opening 28 formed in an enlarged thickness area 20. The opening 28 is designed to accommodate a capacity changing means comprising a rack 7 having a gear-shaped surface 26 formed on an upper portion of said rack 7. A pinion or gear 6 is adapted to cooperate with the gear shaped surface 26. One end of the rack 7 is connected to a movable partition 8 vertically extending throughout the complete inner perimeter of the chamber 18. To facilitate an air tight seal, partition 8 has a rubber seal 8a formed around the edge of the partition 8. A hand lever 5 located on the outside wall of the container 2.1 is connected to the pinion 6. When hand lever is rotated, it rotates pinion 6 which interacts with gear surface of rack 7. Since rack 7 is connected to the movable partition 8, rotation of handle 5 cause partition 8 to move alongside the chamber 18.

In one embodiment, second container 2.1 is provided with a horizontally oriented measuring scale 11 located on vertical wall of chamber 18 allowing to see the scale of ratios that can be produced between first and second containers. The position of movable partition 8 indicates the selected ratio for the desired mixture.

Second container of fixed capacity 2.2 (FIG. 5) is devised to prepare only quantities of fluids in a specific ratio with regards to first container 1. In general, second container 2.2 may be produced in sizes corresponding to volumes most often used in the industry, such as: 16:1, 20:1, 24:1, 32:1, 40:1, 42:1, 50:1, 52:1 and 100:1. In one embodiment, second container 2.2 has an identifier 12 placed on one of the vertical walls (FIG. 5) which indicates the volume ratio between this container and first container.

In another embodiment of the present invention, both first and second containers are provided with transparent reading scales 10 (FIG. 2) located along vertical walls and covering the height from the bottom portion of those containers to the maximum fill level. This transparent reading scale 11 allows to see the level of fluids in each container.

In use, to prepare a desired mixture the user sets second container of variable capacity to the desired ratio or uses second container of fixed capacity having the desired ratio. Both first and second containers are joined together by interlocking means or set of sleeves and rails in order to ensure a common base and permit side by side reading of both level indicators; this is a very important point of the present invention. An undetermined quantity of primary fluid is introduced in the first container. Then, secondary fluid is introduced into second container so that it aligns to the same level as fluid in the first container. This point is also a very important feature of the present invention. Once both fluids are filled into containers, they can be mixed either in the first container or in any other vessel. Such mixture will have exactly desired ratio, which is very important advantage of present invention over prior art.

Both first and second containers are configured so that volume to height ratio of fluid in each container remains the same. Each time the user aligns fluid in first and second containers at the same level, he will get always a desired ratio. It does not matter if these containers are not filled to capacity, since volume to height ratio of fluid in each container remains absolutely identical. This unique relationship between the shapes of both containers eliminates the necessity to completely fill both containers to get a desired ratio. The only conditions required according to the present invention are to assure that both containers are placed on a common surface and are filled up to the same level.

To illustrate this feature more clearly, it is almost impossible to respect volume to height ratio if the first container is rectangular and the second container is round, because while volume of fluid along the height of the first container will be constant, volume of fluid in the second container the will change along the height of the second container's tapered wall. However, if both containers have the same round shape, volume to height ratio will remain constant in both containers.

Although sizes of containers are not relevant, containers may be made in several formats in order to accommodate market demand. For example, typically first container may be manufactured in 1, 2, 5, and 10 gallon formats in one case and 5, 10, 15, 20, and 25 in another case.

There are suggested 10 variants for second container of fixed capacity, because there are now 10 standard ratios used on the market for a gas/oil mixture, such as 16, 20, 24, 32, 40, 42, 50, 52, 64 and 100. Variable type second container is designed to cover all of those ratios, which is a substantial advantage of the present invention.

It is also possible to mix more than two fluids. In this case, an additional second container will be required for each additional mixture.

Suggested materials for manufacture of both containers may be plastic, similar to that used to make gas containers by means of plastic moulding. In case of variable design 2.1, rubber will be required to facilitate tight seal between inner walls of chamber 18 and movable partition 8.

Main advantage of present invention over prior art is the fact that no calculations are necessary in order to establish correct ratio of mixture and there is no need to have a multiple scale on containers to measure fluids. The only thing the user has to do is to ensure that both containers are filled up to the same level.

Thus, it can be seen that the objects of the present invention have been satisfied by the structure presented hereinabove. While in accordance with the Patent Statutes, only the best mode and preferred embodiments of the present invention have been presented and described in detail, it is to be understood that the invention is not limited thereto or thereby. Accordingly, for an appreciation of the true scope and breadth of the invention, references should be made to the following claims.

1. Mixture preparation device for mixing two fluids comprising:
a first container for primary fluid;
a secondary container for secondary fluid;
said first container and said second container have a configuration wherein volume to height ratio of fluid in each container remains identical;
said first and said second containers are adapted to be placed side by side on a common surface;
wherein the desired ratio is obtained in the condition when the primary fluid of said first container is filled up to the same level as the secondary fluid in said second container.

2. Mixture preparation device for mixing two fluids according to claim 1, wherein said second container is a variable capacity container.

3. Mixture preparation device for mixing fluids according to claim 2, wherein said second container comprises a capacity changing means allowing to select a desired ratio.

4. Mixture preparation device for mixing two fluids according to claim 3, wherein said capacity changing means is a vertically oriented movable partition adapted to be moved inside said container, said movable partition having a configuration adapted to divide said second chamber in an airtight manner.

5. Mixture preparation device for mixing two fluids according to claim 4, wherein said container is divided into a first and a second chamber, said movable partition is located in said second chamber.

6. Mixture preparation device for mixing two fluids according to claim 5, wherein said movable partition is moved within said second chamber by means of a rack interacting with a pinion, said rack is connected to said movable partition.

7. Mixture preparation device for mixing two fluid according to claim 6, wherein said rack and pinion are activated by means of a lever handle mounted on said second container.

8. Mixture preparation device for mixing two fluids according to claim 1, wherein said first and said second containers have a generally rectangular configuration.

9. Mixture preparation device for mixing two fluids according to claim 8, wherein said first and said second containers are adapted to be coupled by interlocking means, said interlocking means are adapted to ensure a common base for said first and second containers.

10. Mixture preparation device for mixing two fluids comprising a combination of:
a first container for primary fluid;
a second container for secondary fluid;
said first container and said second container have a configuration wherein volume to height ratio of fluid in each container remains identical;
wherein said first and said second containers have a configuration allowing to obtain the desired ratio of said mixture in the condition when the respective fluids of said first and said second containers are filled up to the same levels.

11. Mixture preparation device for mixing two fluids according to claim 10, wherein said second container is a variable capacity container.

12. Mixture preparation device for mixing two fluids according to claim 11, wherein said second container comprises a capacity changing means allowing to select a desired ratio.

13. Mixture preparation device for mixing two fluids according to claim 12, wherein said capacity changing means is a vertically oriented movable partition adapted to be moved inside of said container, said movable partition having a configuration adapted to divide said second chamber in an airtight manner.

14. Mixture preparation device for mixing two fluids according to claim 13, wherein said container is divided into a first and a second chambers, said movable partition is located in said second chamber.

15. Mixture preparation device for mixing two fluids according to claim 14, wherein said movable partition is moved within said second chamber by means of a rack interacting with a pinion, said rack is connected to said movable partition.

16. Mixture preparation device for mixing two fluid according to claim 15, wherein said rack and pinion are activated by means of a lever handle mounted on said second container.

17. Mixture preparation device for mixing two fluids according to claim 10, wherein said first and said second containers have a generally rectangular configuration.

18. Mixture preparation device for mixing two fluids according to claim 17, wherein said first and said second containers are adapted to be coupled by interlocking means, said interlocking means are adapted to ensure a common base for said first and second containers.

19. Variable capacity container for mixture preparation device for mixing two fluids comprising:
a capacity changing means located inside of said container, wherein said capacity changing means allows to select a desired ratio of a secondary fluid placed in said variable capacity container.

20. Variable capacity container according to claim 19, wherein said capacity changing means is a vertically oriented movable partition adapted to be moved inside of said container, said movable partition having a configuration adapted to divide said container in an airtight manner.

21. Variable capacity container according to claim 20, wherein said container is divided into a first and a second chambers, said movable partition is located in said second chamber.

22. Variable capacity container according to claim 21, wherein said movable partition is moved within said second chamber by means of a rack interacting with a pinion, said rack is connected to said movable partition.

23. Variable capacity container according to claim 22, wherein said rack and pinion are activated by means of a lever handle mounted on said container.
